(19) United States
(12) Patent Application Publication
(10) Pub. No.: US 2008/0143544 A1
(43) Pub. Date: Jun. 19, 2008

(54) Infant safety seat and alarm systems

(76) Inventor: Luis Robles-Figueroa, Bayamon, PR (US)

Correspondence Address: Hector M. Reyes Rivera, PhD JD;Hato Rey Station, P O Box 190086, San Juan, PR, 00919, US

(21) Appl. No.: 11/638,181

(22) Filed: Dec. 13, 2006

(51) Int. Cl. G08B 21/00; B60N 2/28

(52) U.S. Cl. 340/667; 297/253

(57) ABSTRACT

An infant weight-responsive safety seat for using within a motor vehicle is provided. The said infant seat may be integrated as part of an infant detection system that is able of warning the exiting driver the presence of an infant or child left behind within the infant safety seat. The said safety detection system may use different types energy sources or alarm units; depending on the vehicle's electrical system and the consumer's convenience. Alternatively, the said safety detection systems may be used as portable, easy removable units, no internally integrated to an infant safety seat, providing a safety detection system able to be adapted to fit any infant safety seat.

### BACKGROUND OF THE INVENTION

1. Field of the Invention

The present invention relates in general to safety seat and safety seat systems for infant detection in a vehicle able to generate an alarm when the driver exits the vehicle and the infant is present in the safety seat. More particularly the invention relates to an infant weight-responsive safety seat and safety seat system or circuit having energy sources of different nature. The said system or circuit may be integrated physically and internally in the said infant weight-responsive safety seat or alternatively, it may be use externally as portable, easy removable manner in such a way that it may be adapted to fit any infant safety seat available in the market.

2. Description of Related Art

Forgetfulness of an infant inside a vehicle after arriving to a given destination and exiting the vehicle is a tragic event. Most of these incidents end up with the negligent death of the infant. The tragedy is even worse when the person in charge of transporting the infant is one of the infant's relatives, particularly the parents.

Thus, in response of such need it is an objective of the instant invention to provide an infant weight-responsive safety seat useful in transporting an infant in a vehicle and wherein the said seat is adaptable to a safety system or circuit comprising an alarm unit and an energy source. The said system is able to alarm the exiting driver of the presence of the infant in the said safety seat. The said safety system or electrical circuit may have energy sources of different nature, depending of the vehicle's electric system and/or the vehicle's user preferences. Therefore, the herein disclosed infant weight-responsive safety seat is versatile regarding the nature of the circuit wherein it is integrated, offering different options to the users, depending on the electrical system of user's vehicle and the user's convenience. The said system or circuit may be integrated physically and internally in the said infant weight-responsive safety seat or alternatively, it may be used externally in a portable, easy removable manner in such a way that it may be adapted to fit any infant safety seat available in the market.

### SUMMARY OF THE INVENTION

The invention provides a detachable weight-responsive safety seat for infants useful when transporting an infant in a vehicle; which is adaptable to an electrical system or circuit that is able to alarm or remind the exiting driver of the presence of an infant left behind in a motor vehicle. The said safety seat comprises three detachable units: a cover, a carrier and a seat. Additionally, it also comprises a weight-responsive safety switch activated with the infant's weight and at least two additional switches located preferably in between the base unit and the carrier unit. The said electrical unit comprising the weight-responsive switch may be physically integrated to the infant safety seat or it may be totally removable from the said safety seat and use externally, in such a way that it may be adapted to any infant safety seat in the market.

The said infant safety seat is adaptable to multiple infant safety systems comprising an energy source and means for generating an alarm signal able to alarm and to remind the driver exiting the vehicle the presence of an infant left behind in the vehicle. The said infant safety seat systems are versatile in the sense that each one of the said circuits having energy sources and alarms units of diverse nature, thus allowing the user of the system to choose among the alternative circuits depending of the user's needs, the vehicle's electrical system or the user's convenience. The said infant safety seat system or circuit may be physically integrated to the infant safety seat or it may be portable and totally removable from the said safety seat and use externally in such a way that it may be adapted to fit any vehicle infant safety seat that is currently available in the market or will be available in the future in commerce.

The said infant weight-responsive safety seat may be optionally easily and quickly separated from the circuit, thus allowing the entire seat to be attached or detached from the infant safety system or circuit.

Other objects, advantages and applications of the present invention will become apparent to those to those skilled in the art when the following description of the best mode contemplated for practicing the invention and/or preferred embodiments are read in conjunction with the accompanying drawings.

### BRIEF DESCRIPTION OF THE DRAWINGS

FIG. 1 shows a perspective view of a prototype the kind of detachable infant seat that may be use in the instant invention. It is illustrated in its separate main units: cover, carrier and base.

FIG. 2 shows a block diagram of the electrical connections and switches located in the detachable infant seat of the invention.

FIG. 3A shows an internal sectional view of one prototype of the weight-responsive switch located in the carrier unit of the safety seat. FIG. 3B shows a top view of the said infant weight-responsive switch prototype.

FIG. 4 shows a bottom view of the safety seat carrier unit prototype showing the upper parts of the switches that allow the electric flow input and electric flow output in the said infant weight-responsive safety seat.

FIG. 5 shows a top view of the safety seat base prototype unit showing the lower parts of the switches that allow the electric flow input and electric flow output in the said infant weight-responsive safety seat.

FIG. 6 shows a diagram wherein the infant weight-responsive safety seat is electrically connected to a circuit having as energy source a part of the vehicle's electric system or a vehicle's electrical device that turns on after the vehicle ignition has been turned off. The said energy sources only remains on for a short period of time, for instance, the ceiling lights and the side doors lights.

FIG. 7 shows a diagram shows a diagram wherein the infant weight-responsive safety seat is electrically connected to a circuit having as energy source a part of the vehicle's electric system or a vehicle's electrical device which continues on even after turning the vehicle's ignition off, such as some cigarettes lighters or car battery.

FIG. 8 shows a diagram wherein the infant weight-responsive safety seat is electrically connected to a circuit having as energy source a part of the vehicle's electric system or a vehicle's electrical device which turns off simultaneously to turning the car's ignition off, such as some cigarettes lighters, or radios wiring, car windows wiring or safety belts wiring wherein an alternative battery is constantly charging while the vehicle is on and the circuit is in the open state.

### DETAILED DESCRIPTION OF THE INVENTION

Referring to the drawings, the present invention will now be described in detail with reference to the preferred embodiments. The terms infant or child in the present invention are used interchangeable and it refers to newborns and small children having at least a minimum weight of four pounds.

The means for generating an alarm signal or the alarm unit required in the present invention may be any suitable alarm systems, such as those already known in the art. It may be an audible alarm type, a visual alarm type or any possible lights and sounds alarm unit combinations that may be integrated to a car alarm systems.

The relative physical position of the terms “second electrical switch” and “third electrical switch” may be interchangeable since the said terms are only used to illustrate the said electrical switches and to describe the same.

The physical position of the electric input and the electric output may be located in any place of the seat and they may even be integrated as a single unity containing both connections.

The described safety system comprising switches and its electrical connections may be integrated in an infant safety seat or it may be externally use and not physically integrated to the internal sections of the said seat in such a way that it may be adapted to fit any infant safety seat commercially available or infant safety seats that will be available in the market.

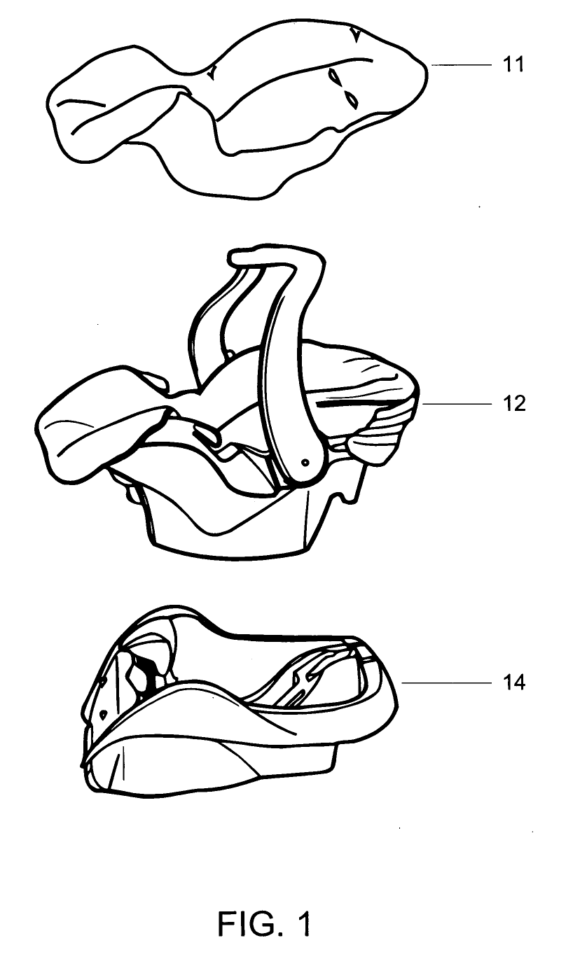

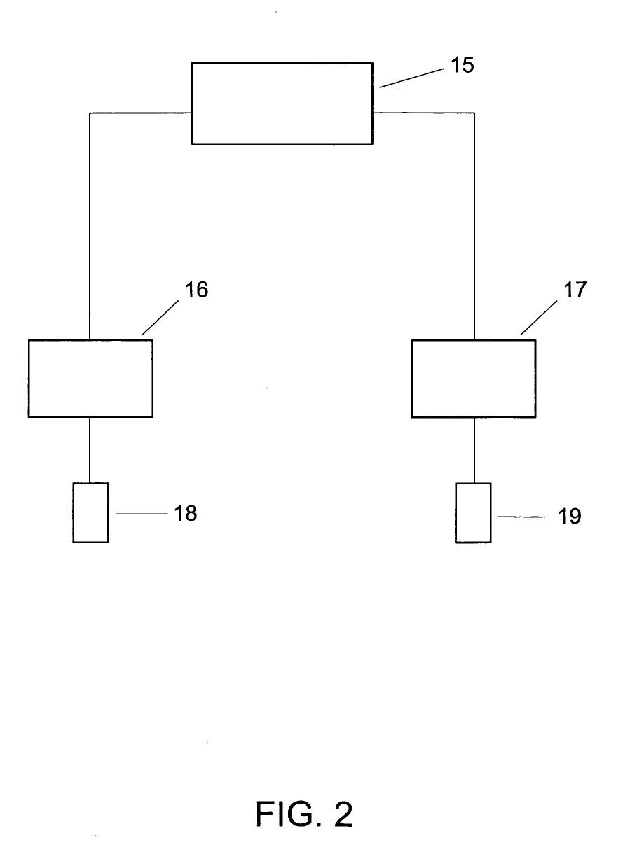

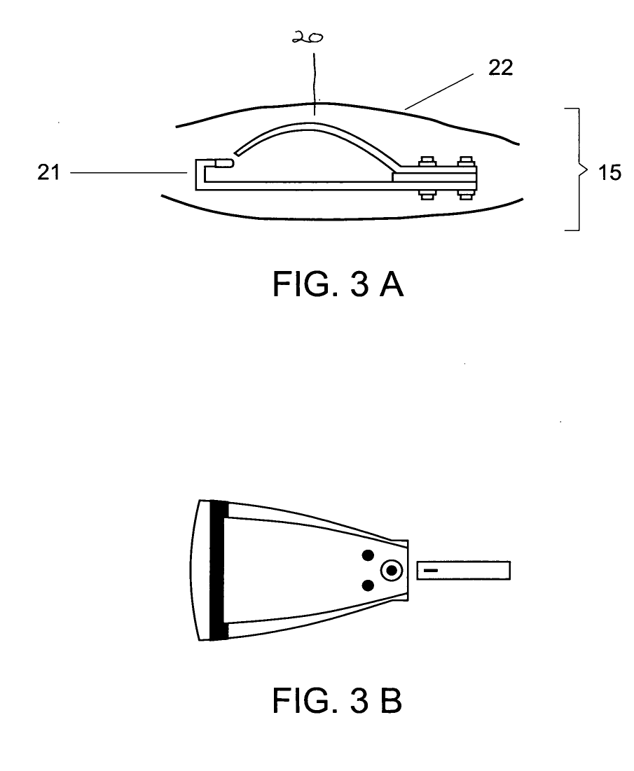

Referring to FIG. 1, it illustrates a prototype of a kind of infant safety seat 10 used to illustrate the practice the invention. The said seat 10 is useful in transporting infants in a vehicle. Its main units are cover 11, which is placed in the upper part of carrier 12. On the other hand, base 14 is attached to the lower part of carrier 12. Once the units are attached, the said seat 10 is placed conventionally in the vehicle's rear seat. The said seat types are conventionally use in the art. Nonetheless, the instant infant weight responsive safety seat also comprises a series of electrical switches and its electrical connections that are illustrated in FIG. 2. Located in carrier 12 is a weight-responsive electrical switch 15. The said switch 15 is responsive to the infant's weight, thus it is in close state whenever the infant is seated in the carrier; otherwise it is biased open. The said switch 15 may be any weight-responsive switch sensible to the infant's weight and it may be placed in any location of carrier 12, wherein the infant's weight promptly effect the close state of the said switch 15. It may be internally located in the covers material or placed outside of the interior of the cover 12. FIG. 3A, is a cross view illustrating a prototype of the said weight-responsive switch, without limiting the invention to the used of the illustrated prototype. Notice that once the weight of the infant is over section 20 of the switch 15, it is sensitively push down to the part 21 of the said switch and thus closing the electric switch 15. The illustrated switch 15 is wrapped in a suitable material 22 in order to protect the infant's skin without affecting the sensitivity of the switch 15.

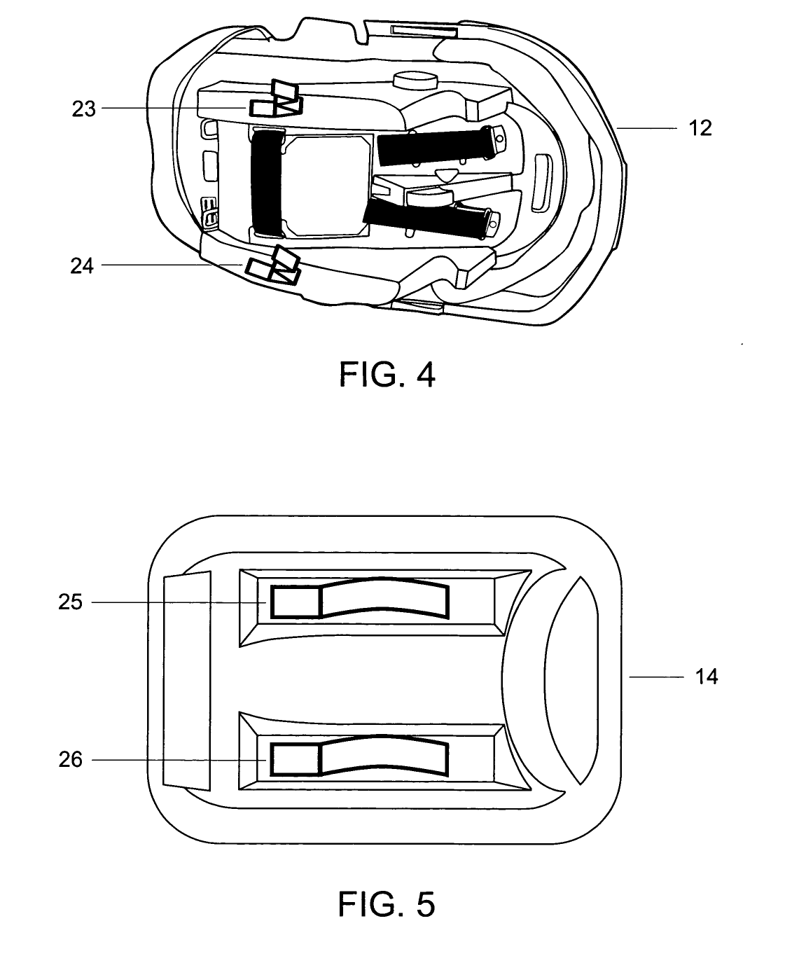

Electric switch 15 is coupled to switch 16 and switch 17 by appropriate electric wiring. Both switches 16 and 17 may be any electrical switches that allow the passing of electrical flow from one side of the seat 10 to the other but passing through electrical switch 15 before the said electric flow goes out of the seat 10. Each one of the said electric switches comprises two main parts: an upper part and a lower part. They can be located in any area of the seat 10, but it is preferred that the said switches be located between carrier 12 and base unit 14. Even more preferably, that the upper part of each one of the switches 16 and 17 are located at the bottom of the carrier 12, as illustrated in numerals 23 and 24 on FIG. 4. On the other hand, it is also preferable that the lower parts of electrical switches 16 and 17 are located in the upper part of the base unit 14, as illustrated in FIG. 5, wherein the numerals 25 and 26 represent the said lower parts of electric switches 16 and 17. Therefore, in the said preferred placement of the said switches 16 and 17, electrical switch 16 comprises upper part 23 and lower part 26 while electrical switch 17 comprises upper part 24 and lower part 25, in such a way that once the carrier 12 and the base 14 are mutually attached to each other and locked, upper part 23 is in contact with lower part 26 and similarly, upper part 24 is in contact with lower part 25 since each one of the said upper and lower parts are positioned perpendicularly to each other, allowing that both electrical switches 16 and 17 are in the close state once the base and the carrier are attached to each other. Once the base 14 and the carrier 12 are detached, electric switches 16 and 17 are biased to be open.

Electrically coupled to electrical switch 16 is an electric input 18, a connector that allows the entering of the electric flow to the safety seat 10. Similarly, electrically coupled to switch 17 is an electric output 19, a connector that allows the exit of the electric flow out of the said seat 10.

The described electrical connection illustrated in FIG. 2 may also be used without it being physically integrated to an infant safety seat since it may be used externally in such a way that it may be adapted to fit any other types of infant safety seat used to safely transport infants in a motor vehicle that is available in the market or that eventually will be available in commerce.

Thus, in the operatively state, an electrical flow enter the safety seat 10 by the electric input 18, it pass through the second switch 16, from where it travels to the weight-responsive switch 15, and then it pass to the third electric switch 17 and to finally travel out of the safety seat via the electric output 19. Notice that the electric flow may only pass through out the safety seat 10 when the base unit 14 is properly attached to the carrier unit 12 and when the infant in present in the carrier. The described detachable seat has the advantages that by removing the infant inside the carrier 12 the alarm system may gets disconnected automatically. Similarly, it also facilitates the easy seat disconnection from the whole infant seat safety system or circuit while simultaneously interrupting the activation the alarm unit. Furthermore, the electric input 18 and electric output 19 allow an easy connection or disconnection of the complete infant weigh-responsive safety seat to the safety system or circuit. The said system may have an energy source of different nature as exemplified below.

The following are examples of infant seat safety systems wherein the described infant weight-responsive safety seat is integrated and wherein the electric sources and alarm units are variable. The following described electrical systems or circuits may also be used without being physically integrated to an infant safety seat since it may be used externally in such a way that it may be adapted to fit any other types of infant safety seat used to safely transport infants in a motor vehicle available in the market or that eventually will be available in commerce.

A. Infant seat safety system electrically connected to an energy unit of the vehicle's electric system or a vehicle's electrical device, which turns on or is activated after the vehicle's ignition has been turned off and wherein the activation of the said energy source only last for a short period of time. Examples of such electric units or devices in many vehicles are the ceiling lights and side door's lights or their corresponding electric connections. The main characteristics of such energy sources is that it only turn on for a short period of time; for instance one or two minutes.

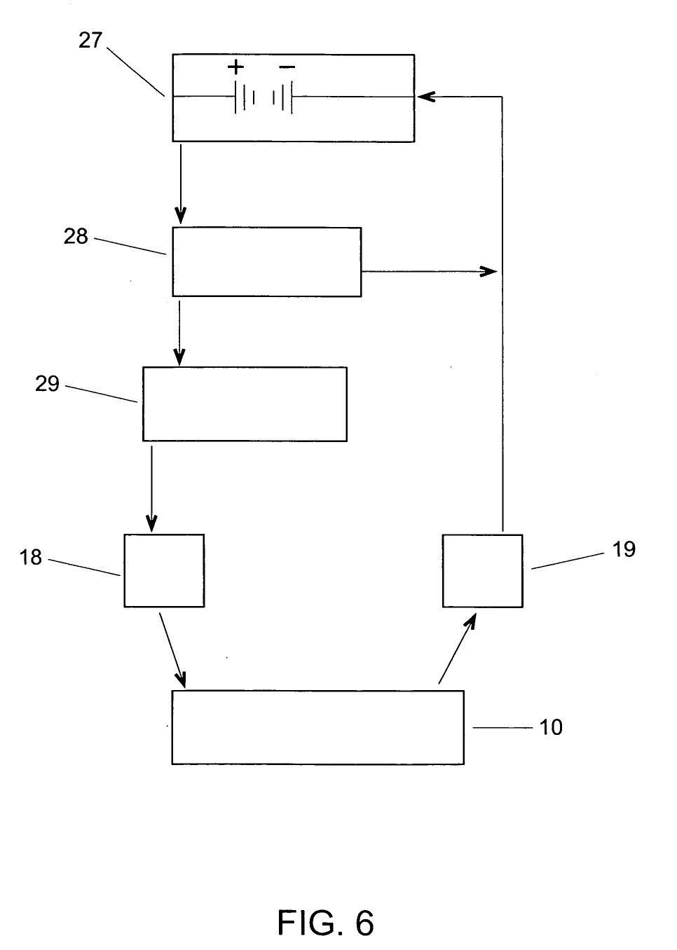

FIG. 6 describes schematically an electric circuit wherein the described safety seat 10 has been integrated and wherein the energy source 27 is a vehicle's electric unit that that turns on after the vehicle ignition has been turned off, such as the vehicle's ceiling lights. The said circuit comprises as basic elements energy source 27, electrically connected or coupled to alarm unit 29 which is electrically connected to the safety seat 10 from where the electric flow returns to the energy source. The light 28 is optional and has its own electric connection back to the energy source since it is only a replacement of the original ceiling or side door light. Similarly, electric input 18 as well as the electric output 19 are optional elements since the seat may be electrically connected directly to the system without need of such electric connectors 18 and 19. This circuit operates by properly installing the safety seat 10 to the rear seat of the vehicle. As mentioned previously, the attachment of base unit 14 and carrier unit 12 maintain electrical switches 16 and 17 in the closed state. After the infant is placed on safety seat 10 the weight-responsive switch 15 remains in the closed state as well as the whole circuit.

Thus, once the driver arrived to the desired destination; the vehicle is turned off and the driver open the door, the energy source is on, thus allowing electric flow to move through the circuit. As a consequence, light 28 immediately turns on and simultaneously alarm unit 29 is activated, alarming the driver that the infant has been left behind inside the closed vehicle. The system is turn off once the infant is removed since the weight responsive electric switch 15 would be open without the presence of the infant in the seat. Alternatively, the system would also turn off by removing the carrier from the base, since electric switches 16 and 17 would be in open state or by removing the whole seat 10 via separation of the connectors 18 and 19 from the circuit.

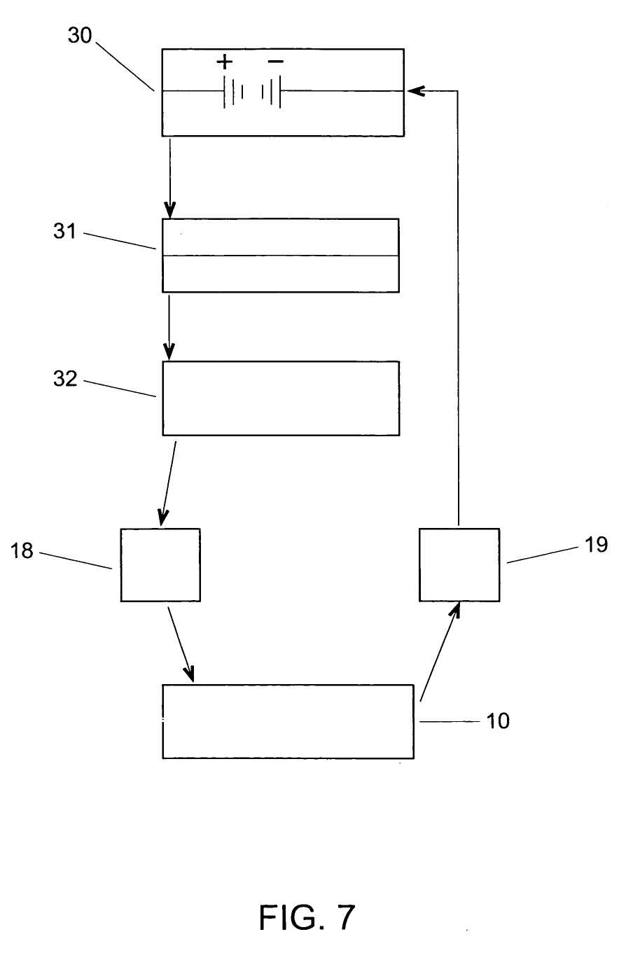

B. FIG. 7 is a diagram of the circuit showing the operating state of the safety system having as energy source a vehicle's electrical unit or vehicle's electrical device which continues on or activated even after turning the vehicle's ignition off or alternatively, an energy source which is independent from the vehicle's electric system.

Diagram in FIG. 7 represents an electric circuit wherein the infant safety seat 10 has been integrated and wherein showing the energy source 30 is any unit or device of the vehicle's electrical system which continues on even after turning the car's ignition off. Some examples of this kind of energy sources are some vehicle's cigarettes lighter, vehicle's battery, radio or their corresponding electric connections. Alternatively, the said energy source 30 may also be independent from the vehicle's electric system such as a suitable independent battery.

Besides energy source 30, the said circuit also comprises as basic elements, alarm unit 31, electrically connected to energy source 30 and to door switch 32. The said switch 32 is coupled to the safety seat 10 from where the electric flow returns to the energy source 30. The door switch 32, conventionally used in the art; remains in open state while the vehicle's door is closed and it is in the close state once the door is open.

As mentioned previously, electric input 18 and the electric output 19 are optional elements since the seat may be electrically connected directly to the system without need of such electric connectors 18 and 19.

Operatively, the system works as follows: the safety seat is properly installed in the rear seat of the vehicle. As mentioned previously, the attachment of base unit 14 and carrier unit 12 maintain electrical switch 16 and electrical switch 17 in the closed state. Once the infant is placed in the safety seat 10, the weight-responsive electric switch 15 is in the close state. Therefore, once the seat is electrically coupled to the circuit, the energy source is on, but the electric flow is controlled by the door switch 32: while the vehicle door is closed, it is in the open state avoiding electric flow through the alarm system. Once the vehicle's door is open, the electric flows through the security system allowing the activation of the alarm unit 31.

Therefore, once the driver arrived to the desired destination and opens the vehicle door to exit, the door switch 32 goes from the open state to the close state, allowing electric flow to move through the circuit and thus activating the alarm unit 31; alarming the driver that the infant has been left behind inside the vehicle. The system is turned off once the infant is removed since the weight responsive electric switch 15 would be open without the presence of the infant in the seat. Alternatively, the system would also turn off by removing the carrier from the base, since electric switches 16 and 17 would be in open state or by removing the whole safety seat from the circuit by disconnecting it from electric connectors 18 and 19.

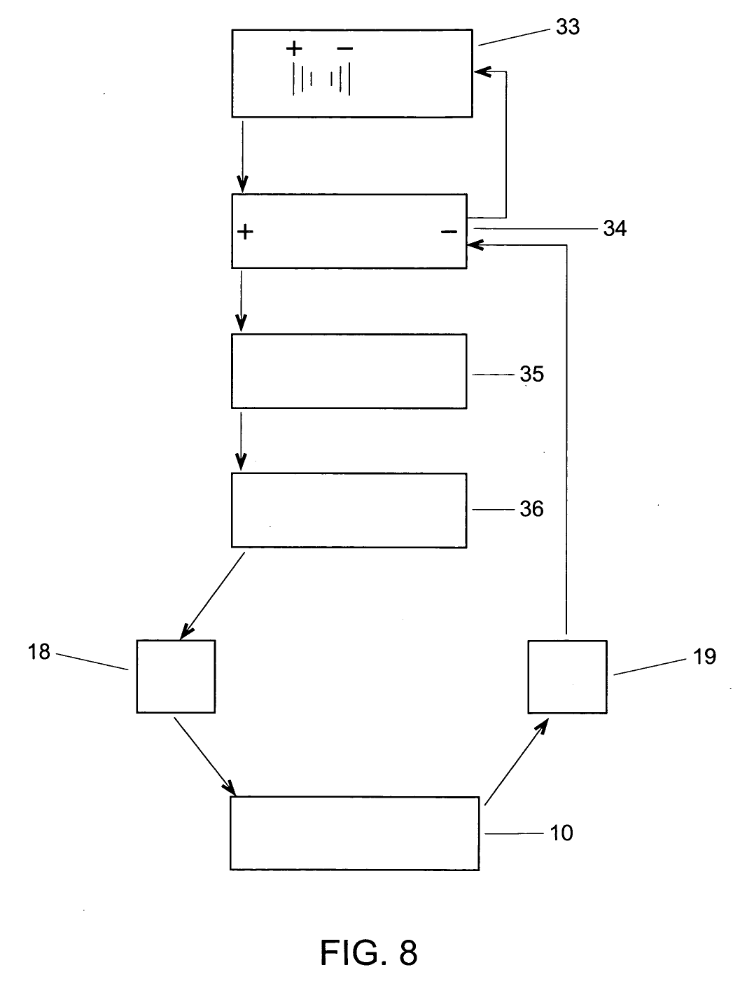

C. FIG. 8 is a diagram of the circuit showing the operating state of the safety system having as energy source any vehicle's electrical device which turns off simultaneously to turning the car's ignition off and wherein battery is constantly charging while the vehicle is on and remains active even after turning the vehicle's ignition off.

Diagram in FIG. 8 describes schematically an electric circuit wherein the described safety seat 10 has been integrated to a circuit requiring and energy source 33, which is a unit or device that is part of the vehicle's electric system. The said energy source is on while the vehicle is on and that it turns off once the vehicle is turned off. Some examples of the said energy sources are some vehicle's cigarettes lighters, vehicle's radios, safety belts, power windows or the corresponding electric connections of the said vehicle's electric units.

On the hand, the system also requires a conventional battery 34, such as a niquel cadmium battery coupled to the said energy source 33. The said battery is constantly charging while the vehicle is on and its energy is available even after turning the vehicle's ignition off.

The said circuit further comprises as basic elements an alarm unit 35, which is electrically coupled to battery 34 and to door switch 36. The said switch door is electrically coupled to the safety seat 10 from where the electric flow returns back to the battery 34.

As mentioned previously, electric input 18 and electric output 19 are optional elements since the seat may be electrically connected directly to the system without need of such electric connectors 18 and 19.

The circuit illustrated in FIG. 8 operates by properly installing the safety seat 10 to the rear seat of the vehicle. As mentioned previously, the attachment of base unit 14 and carrier unit 12 maintain electrical switch 16 and 17 in the closed state. Once the infant is placed in the safety seat 10, the weight-responsive electric switch 15 is in the close state. However, similarly to the diagram of FIG. 7, the door switch 36 controls the current flow and it is in open state whenever the vehicle's door is closed but it is in the closed state when the door is open, and thus the said switch 36 only allows current flow through the circuit when the door is open.

In other words, once the safety seat 10 is installed, the infant is seated on it, the vehicle's doors are closed and the vehicle is started even though the energy source 33 is on, there is no electricity on the circuit because the door's switch 36 remains in open state. The energy source 33, however recharge the battery 34. Once driver arrived to his or her destination, the car ignition is off and the vehicle's door is open, energy source 33 is off, nonetheless energy from the battery 34 circulates the circuit activating the alarm unit 35, remaining the person exiting the vehicle the presence of the infant in the safety vehicle seat.

All systems or circuits illustrated schematically and shown in FIG. 6, 7 and 8 may be used as a portable and removable systems, without being internally integrated to an infant safety seat since them may be used externally in such a way that it may be adapted to fit any other type of infant safety seats used to safely transport infants in a motor vehicle that are available in the market or that eventually will be available in commerce.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best modes contemplated for carrying out the invention, but that the invention will include all embodiments falling within the scope of the appended claims. Moreover, the use of the terms, first, second, third, etc. do not denote any order or importance but rather the terms first, second, third, etc. are used to distinguish one element from another.

What is claimed is:

1) An infant weight-responsive safety seat useful when transporting an infant in a vehicle, said seat being adaptable to an infant or child detection system, wherein the said system is able to remind the driver exiting the vehicle of the presence of an infant and wherein the said seat comprises:
a) an infant's weight-responsive first electrical switch biased to be closed by the infant's weight;
b) a second electrical switch and a third electrical switch, each one of the said second and third electrical switches comprising an upper part and a lower part;
c) means to electrically connect the said first weight-responsive electrical switch to the said second electrical switch and to the said third electrical switch and;
e) means to input an electrical flow through the second switch and means to output the said electrical flow through the third switch after passing through the first weight-sensitive electrical switch; wherein the said means to input and output an electrical flow allow the connection of the said infant safety seat to an electric circuit.

2) An infant weight-responsive safety seat useful when transporting an infant in a vehicle, said seat being adaptable to an infant or child detection system, wherein the said system is able to remind the driver exiting the vehicle of the presence of an infant and wherein the said seat comprises:
a) at least three main detachable units: a cover, a carrier and a base wherein the units are attached by placing the cover on the top of the carrier unit and by connecting the bottom of the carrier unit to the upper part of the base unit;
b) an infant's weight-responsive first electrical switch located on the superior part of the said carrier wherein the said weight-responsive switch is in the close state once an infant is present in the said cover and otherwise biased to be open;
c) a second electrical switch and a third electrical switch, each one of the said second and third electrical switches comprising an upper part and a lower part; wherein the said upper parts are located in the bottom of the said carrier and wherein the said lower parts are located in the upper surface of the said base perpendicularly to the corresponding upper parts and wherein once the base and the carrier are attached, the said second and third switches are in a closed state and when the said carrier and the said base are disconnected both second and third electrical switches are biased to be open;
d) means to electrically connect the said first weight-responsive electrical switch to the said second electrical switch and to the said third electrical switch and;
e) means to input an electrical flow through the second switch and means to output the said electrical flow through the third switch after passing through the first weight-sensitive electrical switch; wherein the said means to input and output an electrical flow allow the connection of the said infant safety seat to an electric circuit.

3) An infant or child detection system able to alarm and remind the driver exiting the vehicle the presence of an infant in the vehicle, said infant safety system comprising:
a) weight-responsive safety seat for infants useful when transporting an infant in a vehicle and wherein the said safety seat comprises at least three main detachable units: a cover, a carrier and a base wherein the units are attached by placing the cover on the top of the carrier unit and by connecting the bottom of the carrier unit to the upper part of the base unit;
b) an infant's weight-responsive first electrical switch located on the superior part of the said carrier wherein the said weight-responsive switch is in the open state once an infant is present in the said cover and otherwise biased to be open;
c) a second electrical switch and a third electrical switch, each one of the said second and third electrical switches comprising an upper part and a lower part; wherein the said upper parts are located in the bottom of the said carrier and wherein the said lower parts are located in the upper surface of the said base perpendicularly to the corresponding upper parts and wherein once the base and the carrier are attached, the said second and third switches are in a closed state and when the said carrier and the said base are disconnected both second and third electrical switches are biased to be open;
d) means for electrically connect the said first weight-responsive electrical switch to the said second electrical switch and to the said third electrical switch and;
e) an alarm unit and;
f) an energy source.

4. The infant detection system of claim 3, wherein the said electrical energy source is independent from or exogenous to the vehicle's electric system.

5. The infant detection system of claim 3, wherein the said electrical energy source is a battery.

6. The infant or child detection system of claim 3, wherein the said energy source is an electrical unit or electrical device of the vehicle's electric system.

7. The infant or child detection system of claim 3, further comprising a vehicle's door's switch.

8. The infant or child detection system of claim 3, wherein the said electrical energy source is electrically connected to the alarm unit and to the third electric switch.

9. A portable and removable system for detecting and reminding the driver exiting a motor vehicle the presence of an infant or child within the said vehicle, wherein the said system is adaptable to fit an infant safety seat and wherein the said removable detecting system comprises:
a) a weight-responsive switch which is in the open state by the action of the said infant's weight and otherwise biased to be open;
b) a first electrical switch;
c) a second electrical switch;
d) means for electrically couple the said weight-responsive electrical switch; to the said first electrical switch and to the said second electrical switch and;
e) means for generating an alarm signal;
f) an energy source and;
wherein the said energy source is electrically coupled to alarm unit and to the said first switch and wherein the said alarm unit is electrically coupled to the said the second switch.

10. The portable and removable system for detecting the presence of an infant or child as claimed in claim 9, further comprising a car door's switch electrically connected between the alarm unit and the second switch.

11. The portable and removable system for detecting the presence of an infant or child as claimed in claim 9, further comprising a light electrically connected between the energy source and the alarm unit.

12. The portable and removable system for detecting the presence of an infant or child as claimed in claim 9, further comprising a battery electrically connected between the energy source and the alarm unit.

13. The portable and removable system for detecting the presence of an infant or child as claimed in claim 9, wherein each one of the said first switch and the said second switch contain two detachable parts: an upper part and a lower part and wherein the said switches are biased closed only when the said parts are in contact to each other.

14. The portable and removable system for detecting the presence of an infant or child as claimed in claim 9, further comprising a first electrical connector between the first switch and the energy source and a second electrical connector between the second electrical switch and the alarm unit; allowing the complete system to be detachable into two units once the said first electrical connector and the said second electrical connector are separated.
